(19) United States
(12) Patent Application Publication
(10) Pub. No.: US 2018/0143659 A1
(43) Pub. Date: May 24, 2018

(54) REFERENCE VOLTAGES

(71) Applicant: Nordic Semiconductor ASA, Trondheim (NO)

(72) Inventors: Carsten WULFF, Trondheim (NO); Carolina Fiorella Inche VELEZMORO, Trondheim (NO)

(73) Assignee: Nordic Semiconductor ASA, Trondheim (NO)

(21) Appl. No.: 15/572,952

(22) PCT Filed: May 11, 2016
(86) PCT No.: PCT/GB2016/051338

§ 371 Date: Nov. 9, 2017

(30) Foreign Application Priority Data
May 12, 2015 (GB) 1508085.6

(51) Int. Cl. G05F 3/24; G05F 1/10; G05F 3/26

(52) U.S. Cl. CPC G05F 3/242; G05F 3/30; G05F 3/267; G05F 1/10

(57) ABSTRACT

A voltage reference circuit comprises a voltage-controlled current source; a first reference metal-oxide-semiconductor field-effect transistor having a first threshold voltage; a second reference metal-oxide-semiconductor field-effect transistor having a second threshold voltage, wherein the second threshold voltage is different to the first threshold voltage; a current mirror; and a load. The voltage-controlled current source is arranged to generate a first current proportional to a difference between the first and second threshold voltages, and the current mirror is arranged to generate a second current that is a scaled version of the first current through the load so as to produce a reference voltage.

The present invention relates to the generation of reference voltages, particularly, although not exclusively, suited for use within an analogue-to-digital converter (henceforth referred to as an ADC). A reference voltage circuit is a key component within an ADC as it provides the reference value to which an analogue input is compared in order to assign the correct digital value.

The reference voltage needs to be of high absolute accuracy in order to achieve sufficient gain error performance. This means that the transfer function of the ADC when physically implemented should match the ideal transfer function as designed as closely as possible. A further factor of importance regarding the reference voltage is that it has a low temperature coefficient so as to reduce the effect of temperature on gain error drift.

Conventional temperature-stable voltage reference circuits are usually constructed using bipolar junction transistors (BJTs), arranged to provide a bandgap reference circuit, so named for producing a 1.25 V output voltage, close to the voltage required for a charge carrier (i.e. an electron or a hole) to overcome the 1.22 eV bandgap associated with silicon at absolute zero. Such a bandgap reference circuit operates using a voltage difference between two p-n junctions operated at different current densities to produce an output voltage with low temperature dependence. However, such bandgap reference circuits typically occupy a significant physical area when implemented in silicon, with some implementations dedicating as much as 20% of the available area of the ADC to the voltage reference circuit.

When viewed from a first aspect, the present invention provides a voltage reference circuit comprising:
a voltage-controlled current source;
a first reference MOSFET having a first threshold voltage;
a second reference MOSFET having a second threshold voltage, said second threshold voltage being different to said first threshold voltage;
a current mirror; and
a load,
   wherein the voltage-controlled current source is arranged to generate a first current proportional to a difference between said first and second threshold voltages, and the current mirror is arranged to generate a second current that is a scaled version of the first current through the load so as to produce a reference voltage.

Thus it will be appreciated by those skilled in the art that the present invention provides a voltage reference circuit that operates by utilising the difference between the respective threshold voltages of two metal-oxide-semiconductor field-effect transistors (MOSFETs). This produces a temperature-stable reference voltage output while minimising physical implementation area requirements. In typical implementations, the present invention may for example require only a quarter of the area that would be required using conventional voltage reference circuits. The current mirror serves to scale the differential threshold voltage dependent output current from the voltage-controlled current source (VCCS) to a desired level, before passing the current through a particular load in order to generate a voltage drop across said load in accordance with Ohm's law, said voltage drop serving as the reference voltage output from the circuit.

There are a number of ways of implementing a voltage-controlled current source known in the art per se. However, in a preferred set of embodiments, the voltage-controlled current source is an operational transconductance amplifier. Within its operating range, an operational transconductance amplifier (OTA) produces an output current that is proportional to the difference between two input voltages. An ideal OTA possess a linear relationship between the differential input voltage and the output current, where there the constant factor relating the two quantities is referred to as the transconductance of the amplifier, gₘ.

The inputs to the voltage controlled current source may be configured such that either of the first and second threshold voltages is greater, as the circuit operates utilising the difference between said threshold voltages. However, in a preferred set of embodiments, said first threshold voltage is greater than said second threshold voltage.

A person skilled in the art will appreciate that the particular threshold voltages associated with these transistors vary with fabrication process. However, in a set of embodiments, the first threshold voltage is between 300 mV and 800 mV. In an overlapping set of embodiments, the second threshold voltage is between 200 mV and 700 mV.

Modern semiconductor design often utilises a standard library approach to application-specific integrated circuit (ASIC) design, wherein a library of standard “building blocks” or “cells” are used to implement desired functions within an ASIC such as an ADC. Threshold voltage transistors are common components of such libraries, and usually exist in triplets, such as a high voltage threshold (HVT), standard voltage threshold (SVT), and low voltage threshold (LVT)—each with a particular characteristic power consumption and critical timing path to be used in applications as the designer sees fit. The Applicant has appreciated the advantages of utilising these transistors, and thus in a set of embodiments, the first reference MOSFET is a high voltage threshold transistor. In another overlapping set of embodiments, the second reference MOSFET is a standard voltage threshold transistor.

The threshold voltage comparison could equally be performed using an LVT, or another type of threshold transistor such as a very high threshold voltage (VHVT) or an extremely low voltage threshold eLVT, in place of either of the aforementioned HVT or SVT transistors. Accordingly, in an alternative set of embodiments, the first reference MOSFET is a standard voltage threshold transistor. In a further alternative set of embodiments, the second reference MOSFET is a low voltage threshold transistor.

In typical implementations, an eLVT may have a threshold voltage between 200 mV and 400 mV; an LVT may have a threshold voltage between 300 mV and 500 mV; an SVT may have a threshold voltage between 400 mV and 600 mV; an HVT may have a threshold voltage between 500 mV and 700 mV; and a VHVT may have a threshold voltage between 600 mV and 800 mV.

The load through which the output current from the voltage-controlled current source is passed may be a load of any type, but is preferably resistive. In a preferred set of embodiments, the load is a variable resistor. By providing a variable load, the reference voltage (i.e. the voltage drop across said load) can be controlled by altering the resistance in accordance with Ohm's law. In a preferred set of embodiments, the variable resistor can be controlled digitally. This allows for fine tuning of the resistance by a microcontroller or any other such device at run-time, allowing for a number of different reference voltages to be generated using the same circuit, and for corrections to be made to said reference voltage to offset variations due to external factors such as temperature fluctuations.

There are a number of current mirror arrangements known in the art suited to the present invention. However, in a set of preferred embodiments, the current mirror comprises a first mirror transistor and a second mirror transistor. Preferably, these are arranged such that their respective gate terminals are connected to a shared gate voltage. In such arrangements, the first mirror transistor is in a diode-connected configuration (i.e. the gate and drain terminals are connected to each other) and the second mirror transistor is in a common source configuration (i.e. the gate terminal serves as an input and the drain terminal serves as an output). A difference in these transistors allows a first mirror current through the first mirror transistor to be scaled by a factor so as to generate a second mirror current through the second mirror transistor that is proportional to the first mirror current. In a preferred set of embodiments, the first mirror transistor has a first width and the second mirror transistor has a second width, wherein said first and second widths are different. In such embodiments, the ratio between said first and second widths provides a current ratio between said first and second mirror currents. In other embodiments the first and second widths are the same. The drain terminal of the first mirror transistor may be connected to the drain terminal of either of the first and second reference MOSFETs via a fixed resistor, such that a voltage drop across the fixed resistor provides a fixed input voltage to the voltage-controlled current source.

An embodiment of the present invention will now be described, by way of example only, with reference to the accompanying drawings, in which:

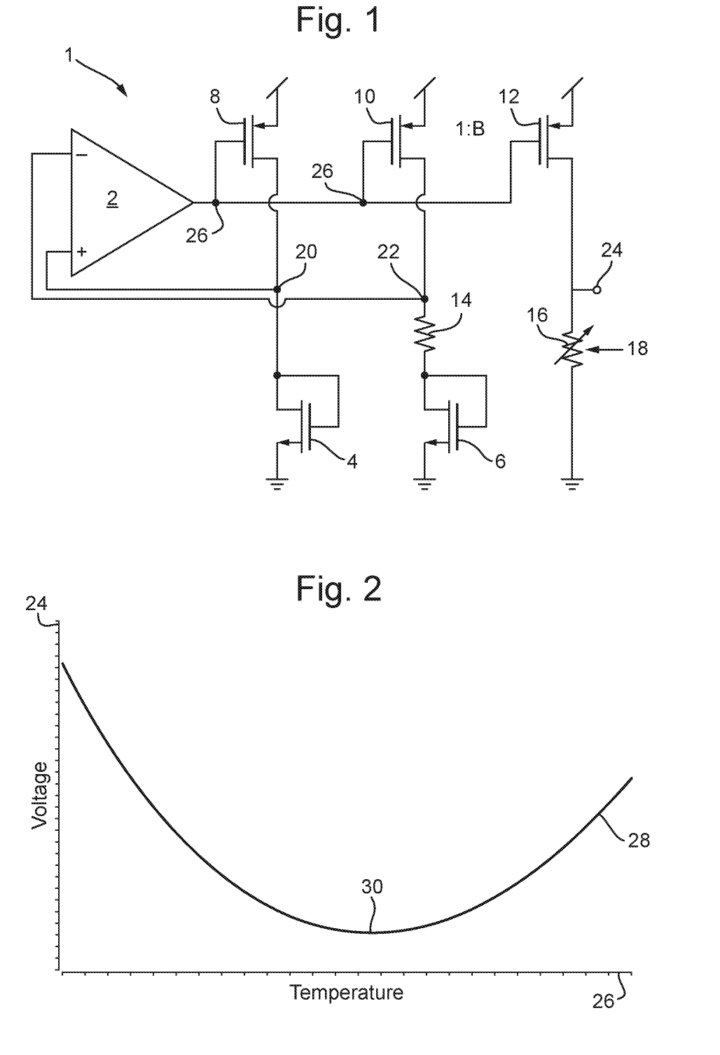

FIG. 1 shows a circuit diagram of a voltage reference circuit in accordance with the present invention; and

FIG. 2 shows a simulated graph of the reference voltage as a function of temperature across a typical operating range.

FIG. 1 shows a circuit diagram of a voltage reference circuit 1 in accordance with the present invention. The voltage reference circuit 1 comprises an operational amplifier 2 configured as an operational transconductance amplifier; an HVT transistor 4; an SVT transistor 6; first and second current source transistors 8, 10; a current mirror transistor 12, a fixed resistor 14, and a digitally controllable variable resistor 16 having a digital control input 18.

The first and second current source transistors 8, 10 supply the HVT and SVT transistors 4, 6 respectively with current, which in turn generate input voltages 20, 22 that are supplied to the operational amplifier 2. The HVT and SVT transistors 4, 6 are arranged such that their individual gate and drain terminals are connected, and are further connected to the non-inverting and inverting inputs of the operational amplifier 2 respectively. In the case of the SVT transistor 6, the common gate and drain terminals are connected to the inverting input of the operational amplifier 2 via the fixed resistor 14.

The current supplied by the second current source transistor 10 passes through the fixed resistor 14 and generates a voltage drop across it in accordance with Ohm's law. This voltage drop provides the inverting input 22 to the operational amplifier 2. As the amplifier output voltage 26 from the operational amplifier 2 is connected to the gates of the first and second current source transistors 8, 10, the channel widths of said transistors are altered so as to drive the non-inverting and inverting input voltages 20, 22 toward convergence. Since the HVT and SVT transistors 4, 6 have different threshold voltages due to their physical differences, the difference in the voltages 20, 22 must be compensated for by altering the voltage drop across the fixed resistor 14.

The current mirror transistor 12 is physically wider than the second current source transistor 10 by a factor B. Due to this difference in widths, the current through the current mirror transistor 12 is B times greater than the current through the second current source transistor 10. This greater mirrored current is then passed through the variable resistor 16, producing the reference voltage output 24.

An n-bit digital control signal 18 is supplied to the variable resistor 16, which in turn causes the resistance to change as desired. This variable resistance allows for fine tuning of the reference voltage output 24 at run-time.

Thus it can be seen that the reference voltage output 24 is based on the threshold voltage difference between the HVT and SVT transistors 4, 6.

Here it is assumed that the HVT and SVT transistors 4, 6 are in weak inversion. This means that the potential difference across the gate and source terminals of each transistor is less than the threshold voltage of said transistor (i.e. V_{Gs}<Vₜₕ). As such, the transistors are operating within their respective subthreshold regions and their respective drain currents are given by Equation 1, recited from Solid State Electronic Devices (Streetman Banerjee, page 311).

$${I}_{D} = μ ( {C}_{D} + {C}_{it} ) \frac{W}{L} {( \frac{KT}{q} )}^{2} ( 1 - {e}^{\frac{- {V}_{D}}{\frac{KT}{q}}} ) ( {e}^{\frac{q ( {V}_{G} - {V}_{TH} )}{nKT}} ) \qquad Equation 1$$

Where n is a variable which depends on the depletion capacitance of the channel C_{d}, interface-state MOS capacitance Cᵢₜ and insulator capacitance Cᵢ, given by Equation 2 below.

$$n = [ 1 + \frac{{C}_{d} + {C}_{it}}{{C}_{i}} ] \qquad Equation 2$$

To simplify I_{D}, the first term is defined as I₀ as in Equation 3.

$${I}_{0} = μ ( {C}_{D} + {C}_{it} ) \frac{W}{L} {( \frac{KT}{q} )}^{2} \qquad Equation 3$$

If it is assumed that

$${V}_{D} > \frac{KT}{q} , then ( 1 - {e}^{\frac{- {V}_{D}}{\frac{KT}{q}}} ) \approx 1. \qquad$$

By making this approximation and substituting Equation 3 into Equation 1, the drain current I_{D} can be expressed as follows in Equation 4.

$${I}_{D} = {I}_{0} {e}^{\frac{q ( {V}_{G} - {V}_{TH} )}{nKT}} \qquad Equation 4$$

Then the gate-source voltages V_{GS} for each of the HVT and SVT transistors 4, 6 can be expressed as shown below in Equations 5 and 6 respectively.

$$\begin{matrix}{V}_{GS\_HVT} = {V}_{TH\_HVT} + \frac{{n}_{HVT} KT}{q} ln ( \frac{{I}_{D\_HVT}}{{I}_{0 \_HVT}} ) & Equation 5 \\ {V}_{GS\_SVT} = {H}_{TH\_SVT} + \frac{{n}_{SVT} KT}{q} ln ( \frac{{I}_{D\_SVT}}{{I}_{0 \_SVT}} ) & Equation 6\end{matrix}$$

Equation 7 introduces a parameter s, where s represents the subthreshold slope and is given by.

$$s = ln ( 10 ) \frac{KT}{q} [ \frac{1 + ( {C}_{d} + {C}_{it} )}{{C}_{i}} ] \qquad Equation 7$$

By substituting Equation 2 into Equation 7 and solving for n, the expression of Equation 8 is obtained.

$$n = \frac{s \frac{q}{KT}}{ln ( 10 )} \qquad Equation 8$$

By substituting Equation 8 into Equations 5 and 6, the following expressions for V_{GS}_{_}_{HVT} and V_{GS}_{_}_{SVT} as provided in Equations 9 and 10 respectively are found.

$$\begin{matrix}{V}_{GS\_HVT} = {V}_{TH\_HVT} + \frac{{s}_{HVT}}{ln ( 10 )} ln ( \frac{{I}_{D\_HVT}}{{I}_{0 \_HVT}} ) & Equation 9 \\ {V}_{{GS}_{SVT}} = {V}_{{TH}_{SVT}} + \frac{{s}_{SVT}}{ln ( 10 )} ln ( \frac{{I}_{{D}_{SVT}}}{{I}_{{0}_{SVT}}} ) & Equation 10\end{matrix}$$

As the operational transconductance amplifier in FIG. 1 ensures that the voltages 20 and 22 are equal, the gate-source voltage of the HVT transistor 4 must equal the sum of the gate-source voltage of the SVT transistor 6 and the voltage drop across the fixed resistor 14 (i.e. V_{GS}_{_}_{HVT}=V_{GS}_{_}_{SVT}+V_{R0}). Thus the voltage across the resistor 14 V_{R0} denoted is given by Equation 11 below.

V_{R0}=V_{GS}_{_}_{HVT}−V_{GS}_{_}_{SVT} Equation 11

Assuming that the subthreshold slopes of both transistors 4, 6 are similar (i.e. s_{HVT}≈s_{SVT}), the voltage drop V_{R0} across the fixed resistor 14 is given by Equation 12.

$${V}_{R 0} = ( {V}_{TH\_HVT} - {V}_{TH\_SVT} ) + \frac{s}{ln ( 10 )} ln ( \frac{{I}_{0 \_SVT}}{{I}_{0 \_HVT}} ) \qquad Equation 12$$

This can also be expressed in logarithmic form as below in Equation 13 using the relationship

$$log ( x ) = \frac{ln ( x )}{ln ( 10 )} .$$

$${V}_{R 0} = Δ {V}_{{TH}_{HVT / SVT}} + s \cdot log ( \frac{{I}_{0 \_SVT}}{{I}_{0 \_HVT}} ) \qquad Equation 13$$

Replacing I₀ with

$$μ ( {C}_{D} + {C}_{it} ) \frac{W}{L} {( \frac{KT}{q} )}^{2}$$

V_{R0} provides Equation 14 below.

$${V}_{R 0} = Δ {V}_{{TH}_{HVT / SVT}} + s \cdot log ( \frac{{μ}_{0 \_SVT} ( {C}_{D\_SVT} + {C}_{it} ) \frac{{W}_{SVT}}{{L}_{SVT}}}{{μ}_{0 \_HVT} ( {C}_{D\_HVT} + {C}_{it} ) \frac{{W}_{HVT}}{{L}_{HVT}}} ) \qquad Equation 14$$

It is now assumed that the lengths of the HVT and SVT transistors 4, 6 are the same. Since the variable resistor 16 sees a scaled version of the current in the fixed transistor 14, the reference voltage output 24 denoted as V_{REF} is expressed as Equation 15.

$${V}_{REF} = {R}_{1} {BI}_{D} = \frac{{R}_{1}}{{R}_{0}} B [ Δ {V}_{{TH}_{HVT / SVT}} + s \cdot log ( \frac{{μ}_{{0}_{SVT}} ( {C}_{{D}_{SVT}} + {C}_{it} ) {W}_{SVT}}{{μ}_{{0}_{HVT}} ( {C}_{{D}_{HVT}} + {C}_{it} ) {W}_{HVT}} ) ] \qquad Equation 15$$

FIG. 2 shows a simulated graph of the reference voltage 24 as a function of temperature 26 across a typical operating range. From simulation it can be observed that the difference between the threshold voltages of the HVT and SVT transistors 4, 6 (i.e. ΔV_{TH}_{_{HVT/SVT}}) will decrease with temperature, while the second term

$$( s \cdot log ( \frac{{μ}_{{0}_{SVT}} ( {C}_{{D}_{SVT}} + {C}_{it} ) {W}_{SVT}}{{μ}_{{0}_{HVT}} ( {C}_{{D}_{HVT}} + {C}_{it} ) {W}_{HVT}} ) )$$

will increase with temperature if the logarithmic term is greater than one.

The trace 28 within FIG. 2 shows that each of these effects dominates at opposing extremes, increasing the reference voltage 24, as the temperature varies either side of a minimal point 30.

Thus it will be seen that voltage reference circuit has been described. Although a particular embodiment has been described in detail, many variations and modifications are possible within the scope of the invention.

1. A voltage reference circuit comprising:
a voltage-controlled current source;
a first reference metal-oxide-semiconductor field-effect transistor having a first threshold voltage;
a second reference metal-oxide-semiconductor field-effect transistor having a second threshold voltage, said second threshold voltage being different to said first threshold voltage;
a current mirror; and
a load,
wherein the voltage-controlled current source is arranged to generate a first current proportional to a difference between said first and second threshold voltages, and the current mirror is arranged to generate a second current that is a scaled version of the first current through the load so as to produce a reference voltage.

2. The voltage reference circuit as claimed in claim 1, wherein the voltage-controlled current source is an operational transconductance amplifier.

3. The voltage reference circuit as claimed in claim 1, wherein said first threshold voltage is greater than said second threshold voltage.

4. The voltage reference circuit as claimed in claim 3, wherein the first threshold voltage is between 300 mV and 800 mV.

5. The voltage reference circuit as claimed in claim 3, wherein the second threshold voltage is between 200 mV and 700 mV.

6. The voltage reference circuit as claimed in claim 1, wherein the load is resistive.

7. The voltage reference circuit as claimed in claim 6, wherein the load is a variable resistor.

8. The voltage reference circuit as claimed in claim 1, wherein the current mirror comprises a first mirror transistor and a second mirror transistor.

9. The voltage reference circuit as claimed in claim 8, wherein the first mirror transistor is in a diode-connected configuration.

10. The voltage reference circuit as claimed in claim 8, wherein the second mirror transistor is in a common source configuration.

11. The voltage reference circuit as claimed in claim 8, wherein the first mirror transistor has a first width and the second mirror transistor has a second width, wherein said first and second widths are different.

12. The voltage reference circuit as claimed in claim 8, wherein the first mirror transistor has a first width and the second mirror transistor has a second width, wherein the first and second widths are the same.

13. The voltage reference circuit as claimed in claim 8 wherein the first mirror transistor and a second mirror transistor are arranged such that their respective gate terminals are connected to a shared gate voltage.

14. The voltage reference circuit as claimed in claim 1, wherein the current mirror comprises a first mirror transistor and a second mirror transistor, wherein the first mirror transistor has a first width and the second mirror transistor has a second width, wherein said first and second widths are different.
